(19) United States
(12) Patent Application Publication
(10) Pub. No.: US 2014/0279655 A1
(43) Pub. Date: Sep. 18, 2014

(54) PURCHASE HISTORY SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/215,361

(22) Filed: Mar. 17, 2014

Related U.S. Application Data
(60) Provisional application No. 61/786,461, filed on Mar. 15, 2013.

(51) Int. Cl. G06Q 10/08

(52) U.S. Cl. CPC G06Q 10/0833
USPC 705/333

(57) ABSTRACT

A computer system for providing a user purchase history is disclosed. The computer system receives purchasing and shipping data associated with a user regardless of where the user made a purchase or how the items associated with the purchase were shipped. The system then stores the purchasing and shipping data and enables a user to access the received data in one convenient location via a username and password. In various embodiments, the system also enables the user to print shipping labels and/or the system facilities the return of purchased items.

### CLAIM OF PRIORITY

This application claims the benefit of priority under 35 U.S.C. §119(e) to the filing date of U.S. Provisional Patent Application No. 61/786,461 filed Mar. 15, 2013, entitled, “Purchase History Systems and Related Methods,” which is incorporated herein by reference in its entirety.

### BACKGROUND

When an individual orders a package from an online retailer, the online retailer (opposed to the individual) often selects a logistics company to deliver the package, or the individual may be given the option to choose a logistics company from a list that does not include their preferred logistics provider (e.g., UPS®). As a result, individuals who order items from many different retailers may receive items from a variety of different logistics companies. This may make it difficult for individuals to track the status of their various purchases and inbound deliveries.

Various embodiments of present systems and methods recognize and address the foregoing considerations.

### SUMMARY

According to various embodiments, a computer system for creating a purchase history includes at least one processor and is configured for: 1) receiving first purchasing data associated with a first purchase made by a user and first shipping data associated with the first purchase; 2) receiving second purchasing data associated with a second purchase made by the user and second shipping data associated with the second purchase made by the user; 3) associating, with a purchase history associated with an account associated with the user: i) the first purchasing data; ii) the first shipping data; iii) the second purchasing data; and iv) the second shipping data, wherein accessing the account associated with the user depends, at least in part, on receiving a particular user name and a particular password; 4) receiving a request from the user to access the purchase history, wherein the request from the user to access the purchase history includes the particular user name and the particular password; and 5) at least partially in response to receiving the request from the user to access the purchase history, transmitting the purchase history to a client device associated with the user.

In a particular embodiment, a non-transitory computer-readable medium stores computer executable instructions for: 1) detecting a first purchase from a first online retailer by a user; 2) collecting first purchasing data associated with the first purchase and first shipping data associated with the first purchase; 2) detecting a second purchase from a second online retailer by the user; 3) collecting second purchasing data associated with the second purchase and second shipping data associated with the second purchase; 4) sending, to be included in a user purchase history, to a remote computing system: i) the first purchasing data; ii) the first shipping data; iii) the second purchasing data; and iv) the second shipping data; 5) receiving a request from the user to view the first purchase history; 6) sending the request to the remote computing system; 6) receiving the user purchase history; and 7) displaying the first user purchase history to the first user.

### BRIEF DESCRIPTION OF THE DRAWINGS

Reference will now be made to the accompanying drawings, which are not necessarily drawn to scale, and wherein:

FIG. 1 is a block diagram of a Purchase Tracking System according to one embodiment;

FIG. 2 is a block diagram of an exemplary Logistics Server of FIG. 1;

FIG. 3 shows a flow diagram that generally illustrates various steps executed by the exemplary Purchase History Module in FIG. 2 in accordance with various embodiments of the system of FIG. 1; and

FIGS. 4A and 4B depict screenshots and descriptions of various aspects and embodiments of the exemplary Purchase History Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, provides an enhanced shipping and purchase history. The system may leverage combined purchase and shipping data to create a complete purchasing/shipping history for a user that includes information regarding the user's one or more purchases from any online retailer shipped by any carrier. Additionally, the purchase history may include further information such as statistics regarding the number of items a user returns to a retailer, statistics regarding the number of parcels the user ships and/or receives, and/or statistics regarding the number of items the user purchases. In various embodiments, the system is configured to track purchase and shipping data for a particular user and then provide that purchase and shipping data in response to a request from the user.

To create a purchase history for a user, the system may utilize various types of data, including for example, purchasing data and shipping data. The system may be configured to collect purchase data in any suitable way. In some embodiments, the system collects purchase data from the online retailer website by identifying and collecting the purchase data when the user views a receipt or online purchase confirmation (e.g., the system examines the data of an online retailer website as the user is making a purchase and collects the data). In other embodiments, the system receives the purchase data directly from an online retailer's servers (e.g., the one or more Third Party Servers 35) via any suitable mechanism, including, but not limited to, an API.

In various embodiments, the system is configured to receive shipping data directly from a logistics company's servers (e.g., the Logistic Servers 25), for example, via an API. In other embodiments, the system collects the shipping data via a user's email (e.g., a confirmation e-mail for a purchase made by the user)—by either scraping the email (e.g., accessing an email account associated with the user, scanning the code of the user's one or more emails to detect the shipping data, and collecting the detected shipping data) or by using a browser plug-in to collect the shipping data when the user opens an email (e.g., the browser plug-in scans the information that is on a user's screen and collects shipping information).

In various embodiments, the system may be configured to store and/or access the purchase history in any suitable manner such as, for example, in a database. According to particular embodiments, the system is configured to store the purchase history on a remote server (e.g., the Logistics Server 25) and enable the user to access the purchase history through an account (e.g., using a user name and password). In many embodiments, the system is configured to integrate the purchase history into a social network and allows a user to access the purchase history by accessing the social network. In some embodiments, the purchase history is stored in a database and is accessed by the user through a web browser (e.g., through the Internet).

Additionally, the system may be implemented in various ways by a number of entities. In various embodiments, the system is provided by a logistics company or any other suitable company that can access consumer data. Moreover, the system may be rendered on a user's computing device (laptop computer, desktop computer, mobile device, etc.), on a company's servers, on a social network server, on a third party server (e.g., a retailer's server), or on any combination of user's devices and servers.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Purchase Tracking System 10 according to a particular embodiment. As may be understood from this figure, the Purchase Tracking System 10 may include one or more Computer Networks 15, a Logistics Server 25, one or more Third Party Servers 35 (e.g., a web hosting server, retailer's server, any other server that hosts websites), a Social Network Server 45 (e.g., a server associated with a social network), a Data Structure 55, and one or more of the following: (1) a Mobile Computing Device 12 (e.g., a handheld computing device, a laptop computer, a tablet computer, or any other mobile computing device); and (2) a Desktop Computer 14.

The one or more Networks 15 facilitate communication between the Mobile Computing Device 12, Desktop Computer 14, Logistics Server 25, Third Party Servers 35, Social Network Server 45, and the Data Structure 55. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, the communication link between the Mobile Computing Device 12, the Desktop Computer 14, the Logistics Server 25, the one or more Third Party Servers 35, the Social Network Server 45, and the Data Structure 55 are implemented via the Internet using Internet Protocol (IP).

It should be understood that the Servers 25, 35, 45 and Data Structure 55 do not necessarily need to be deployed over the network. For example, in various embodiments, any or all of Servers 25, 35, 45, and Data Structure 55 may be deployed locally on the user's computer, tablet, and/or mobile device.

FIG. 2 shows a block diagram of an exemplary embodiment of an exemplary Logistics Server 25 that is configured for executing a Purchase History Module 300. It should be understood based on this disclosure that any suitable computers (e.g., any of the computing devices shown in FIG. 1) may be used to execute this module and that various steps executed by the module may be executed on different computers.

The Logistics Server 25 may include one or more basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD-ROM drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and the Purchase History Module 300. For simplicity and brevity, these modules are merely exemplary and may represent a number of program modules which control certain aspects of the operation of the Logistics Server 25 with the assistance of the Processor 60 and the Operating System 80. The Purchase History Module 300 is described in more detail below.

### Exemplary Purchase History Module

As shown in FIG. 3, certain embodiments of the Purchase History Module 300 are configured to gather and use consumer retail purchasing and shipping data. The Purchase History Module 300 may operate alone or in combination with the Operating System 80 to perform the functions shown in FIG. 3. It should be understood by one skilled in the art that certain embodiments of a Purchase History Module 300 may perform the functions shown in FIG. 3 in an order other than the order shown in FIG. 3. It should also be understood that various systems, when executing a Purchase History Module 300, may omit particular functions or perform additional functions in performing the functions of the Purchase History Module 300.

### Exemplary Embodiment of the Purchase History Module Shown in FIG. 3

### The System Collects Purchasing and Shipping Data

Beginning at Step 302, the Purchase History Module 300 detects that a first user of a plurality of users has made a first purchase from a first online retailer. The system may be configured to detect the purchase in any suitable way. According to a particular embodiment, the system is configured to detect purchases by identifying purchase data on one or more webpages as a user accesses them. In various embodiments, the system is configured to detect purchases in response to an indication from the user that they have made a purchase (e.g., by using a “check box”) or other webform. In some embodiments, the system is configured to detect a purchase by scraping the user's email for data associated with the purchase (e.g., accessing an email account associated with the user, scanning the code of the user's one or more emails to detect data associated with the first purchase, and collecting the detected data associated with the first purchase.

At Step 304, the System 10 collects purchasing data associated with a first purchase from the first online retailer website and collects shipping data associated with the first purchase. The system may be configured to use any suitable mechanism to collect the purchasing and shipping data. In particular embodiments, the system is configured to collect both the purchasing and shipping data by the same mechanism. For example, the system may collect the purchasing and shipping data with a web browser plug-in.

In various embodiments, the system is configured to collect the purchasing and shipping data by separate mechanisms. For example, in one related embodiment, the system may be configured to collect purchasing data via a web browser plug-in which scans the retailer website for the purchasing data associated with the user and collects the purchasing data. Continuing with this example, the system is configured to collect the shipping data by scraping the user's email.

In other embodiments, the system is configured to collect the purchasing and shipping data by one or more other mechanisms, including, but not limited to: 1) an email plug-in which monitors the user's email for purchases, scans the user's emails to detect the purchasing and/or shipping data, and collects the purchasing and/or shipping data; 2) collecting the data from a third party (e.g., a retailer or the retailer's servers) via an API; and 3) a web form containing the shipping and/or purchasing data which is provided to the first user, filled out by the first user, and submitted by the first user to the system. In a particular embodiment, where the system is associated with a logistics company, the shipping data may be provided by the logistics company's one or more servers (e.g., the Logistics Server 25).

In various embodiments, the system may be configured to collect the purchasing data at a different time than the shipping data. In some embodiments, the system is configured to collect the purchasing data substantially immediately (e.g., immediately) after the first user makes a purchase, but does not collect the shipping data until the user receives an email with shipping information associated with the first user's purchase. In another embodiment, the system is configured to collect the purchasing data substantially immediately (e.g., immediately) after the purchase and receives the shipping data associated with the first user's purchase from a logistics server (e.g., the Logistics Server 25) as soon as a shipping order is made with the logistics company.

The purchasing data may include any suitable purchase information such as, for example, an order number for the purchase, a description of the one or more items purchased, one or more prices of the one or more items purchased, a date of purchase, and data associated with the user making the purchase. The shipping data may include any suitable shipping information such as, for example, the order number for the purchase, a tracking number associated with one or more parcels used to ship one or more items of the first purchase, and data associated with the user making the purchase. The shipping data may (or may not) include data that is identical to the purchasing data. However, in a preferred embodiment, the shipping data and the purchasing data include common information (e.g., an order number for the purchase) or a combination of information that is common to both types of data, so the system can associate each type of data with a particular purchase by a particular user.

Returning to Step 306, the system detects a second purchase by the first user from a second online retailer. The system may be configured, for example, to detect the second purchase by any of the ways (or other ways) the system is configured to detect the first purchase in Step 302 discussed above. In various embodiments, the first online retailer and the second online retailer are the same retailer. According to a particular embodiment, the second purchase is for one or more different items than the one or more items of the first purchase. In other embodiments, the second purchase is for items that are identical to the item(s) in the first purchase.

At Step 308, the system collects purchasing and shipping data associated with the second purchase. The purchasing and shipping data associated with the second purchase may be collected in any of the ways (or other ways) as the first purchase shipping and purchasing data in Step 304 discussed above.

The System Includes the Collected Data in a Purchase History Associated with a User

At Step 310, the system sends, to a server for inclusion in a purchase history associated with the user: 1) the first purchase purchasing data; 2) the first purchase shipping data; 3) the second purchase purchasing data; and 4) the second purchase shipping data. In various embodiments, the system is configured to send the data via a network connection, the Internet, or other available means for communication. Additionally, the system may be configured to send each different type of data at different times.

### The System Provides the Purchase History to a User

At Step 312, the system receives a request from the first user to view the first user purchase history, wherein the first user purchase history includes: 1) the first purchase purchasing data associated with the first purchase shipping data; and 2) the second purchase purchasing data associated with the second purchase shipping data. According to various embodiments, the system is configured to receive the request at least partially in response to (e.g., in response to) the first user logging into an account to access the purchase history. In other embodiments, the system is configured to receive the request at least partially in response to the first user submitting data associated with a purchase made by the first user including a purchase order and/or tracking number.

The first user purchase history, in particular embodiments, may include any other suitable data. In various embodiments, the first user purchase history includes return data relating to items the user has returned to online retailers (e.g., because the items are defective). According to a particular embodiment, the first user data includes the first user's preferred shipping method. According to another embodiment, the first user purchase history includes detailed descriptions of prior purchases by the first user associated with the system and organized by category, retailer, type of purchase, and/or price. In further embodiments, the first user purchase history includes statistics about the first user's purchases, returns, and shipping habits.

At Step 314, the system sends a request to the server for the first user purchase history. According to various embodiments, the system is configured to send a request that includes substantially identical (e.g., identical) information as the request received from the first user in Step 312 (e.g., the first user sent a request to the system that included a tracking number; the system sends the request to the server in which the request includes the tracking number). In further embodiments, the system is configured to send a request with different information than the request received by the system from the first user. In still further embodiments, the system is configured to modify the request received from the first user before sending the request to the server. For example, the system may translate the first user's request from a tracking number to the first user's account number and password before sending the request to the server.

In various embodiments, the purchase history functionality is part of an online service that enables the first user to track their purchase and shipping history. In some embodiments, the one or more servers may associate the first purchase purchasing data with the first purchase shipping data and the second purchase purchasing data with the second purchase shipping data and store the data to provide a more complete purchasing history. The first user may be able to access their purchasing history through an account, allowing the user to track any package purchased from any retailer and shipped by any carrier (e.g., logistics) company. In various embodiments, the first user purchase history is part of a system provided by a logistics company.

At Step 316, the system receives the first user purchase history from the server and, at Step 318, the system provides the first user purchase history to the first user. In various embodiments, the system is configured to provide the first user history by displaying the first user history to the first user. According to a particular embodiment, the system is configured to display the first user purchase history in a webpage. In other embodiments, the system is configured to display the first user history in a pop-up window. In still other embodiments, the system is configured to display the first user history as part of a browser add-on.

The system may be configured to provide the first user purchase history to the user in one or more other ways. In various embodiments, the system is configured to provide the first user purchase history by integrating the purchase history with a social network through an application and displaying the purchase history on a webpage associated with the social network. In particular embodiments, the system is configured to provide the first user purchase history through an email, a SMS message, a message on a social network, and/or any other suitable mechanism.

### Exemplary Purchase History Module Functionality

FIGS. 4A and 4B depict screenshots of exemplary embodiments of the Purchase History Module 300. The following examples are provided to further enhance understanding of the present systems and methods. It should be understood that the present systems and methods may be embodied in many different forms and the following examples should not be construed as limited to the embodiments set forth herein. Rather, these embodiments are provided so that this disclosure will be thorough and complete, and will fully convey the scope of the present system and method to those skilled in the art.

FIG. 5A shows a user's purchase history (as shown “shipment history”) integrated into a social network (e.g., Facebook®). The purchase history includes, in various embodiments: 1) information regarding all shipments accumulated since this particular user became a member of an online service associated with a logistics company; 2) information regarding one more retailers from which the user has made a purchase; and/or 3) information regarding one or more purchases made by the user from the one or more retailers.

FIG. 5B similarly shows a user's purchase history (“shipment history”) integrated into a social network. In FIG. 5B, the system displays statistics associated with the number ofpackages the user has received. FIG. 5B also depicts other users of the system which, in various embodiments, may be connected (e.g., “friends” on Facebook®) to the user. The information here is from a logistics server (e.g., the Logistics Server 25) and/or a third party retailer server or site (e.g., the one or more Third Party Servers 35).

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for creating a purchase history comprising:
at least one processor, wherein the computer system is configured for:
(A) receiving:
i) first purchasing data associated with a first purchase made by a user; and
ii) first shipping data associated with the first purchase;
(B) receiving:
i) second purchasing data associated with a second purchase made by the user; and
ii) second shipping data associated with the second purchase made by the user;
(C) associating, with a purchase history associated with the user:
i) the first purchasing data;
ii) the first shipping data;
iii) the second purchasing data; and
iv) the second shipping data;
(D) receiving a request from the user to access the purchase history; and
(E) at least partially in response to receiving the request from the user to access the purchase history, transmitting the purchase history to a client device associated with the user.

2. The computer system of claim 1, wherein the purchase history is associated with an account that is associated with the user.

3. The computer system of claim 2, wherein receiving the request from the user to access the purchase history comprises receiving login information associated with the user account.

4. The computer system of claim 3, wherein the login information and the user account are associated with a particular social network.

5. The computer system of claim 3, wherein the system is further configured for:
(A) determining statistics associated with the purchase history; and
(B) enabling the user to view the statistics at least partially in response to receiving the login information associated with the user account.

6. The computer system of claim 1, wherein the first purchasing data associated with the first purchase made by the user is collected by scraping an email account associated with the user.

7. The computer system of claim 1, wherein the first purchasing data associated with the first purchase made by the user is collected by an email plug-in.

8. The computer system of claim 1, wherein the first purchasing data is collected via a suitable application programming interface.

9. The computer system of claim 8, wherein the first purchasing data comprises data selected from the group consisting of:
(A) an order number for the purchase;
(B) a description of items purchased;
(C) prices of the items purchased;
(D) a date of purchase; and
(E) data associated with a user making the purchase.

10. The computer system of claim 1, wherein the first shipping data comprises data selected from the group consisting of:
(A) an order number for the purchase;
(B) a tracking number; and
(C) data associated with the user making the purchase.

11. A computer system for creating a purchase history comprising:
at least one processor, wherein the computer system is configured for:
(A) receiving:
i) first purchasing data associated with a first purchase made by a user; and
ii) first shipping data associated with the first purchase;
(B) receiving:
i) second purchasing data associated with a second purchase made by the user; and
ii) second shipping data associated with the second purchase made by the user;
(C) associating, with a purchase history associated with an account associated with the user:
i) the first purchasing data;
ii) the first shipping data;
iii) the second purchasing data; and
iv) the second shipping data, wherein accessing the account associated with the user depends, at least in part, on receiving a particular user name and a particular password;
(D) receiving a request from the user to access the purchase history, wherein the request from the user to access the purchase history comprises the particular user name and the particular password; and
(E) at least partially in response to receiving the request from the user to access the purchase history, transmitting the purchase history to a client device associated with the user.

12. The computer system of claim 11, wherein the account associated with the user is a particular account associated with a particular social network.

13. The computer system of claim 12, wherein the particular user name and the particular password are used to access the particular account associated with the particular social network.

14. A non-transitory computer-readable medium storing computer executable instructions for:
(A) detecting a first purchase from a first online retailer by a user;
(B) collecting:
i) first purchasing data associated with the first purchase; and
ii) first shipping data associated with the first purchase;
(C) detecting a second purchase from a second online retailer by the user;
(D) collecting:
i) second purchasing data associated with the second purchase; and
ii) second shipping data associated with the second purchase;
(E) sending, to be included in a user purchase history, to a remote computing system:
i) the first purchasing data;
ii) the first shipping data;
iii) the second purchasing data; and
iv) the second shipping data;
(F) receiving a request from the user to view the first purchase history;
(G) sending the request to the remote computing system;
(H) receiving the user purchase history; and
(I) displaying the first user purchase history to the first user.

15. The non-transitory computer-readable medium of claim 14, wherein the first purchase purchasing data and the first shipping data are each collected from a different source.

16. The non-transitory computer-readable medium of claim 15, wherein the first purchase shipping data is collected by scraping the first user's email.

17. The non-transitory computer-readable medium of claim 14, wherein the computer-executable instructions are adapted for execution by a processor as a web browser add-on.

18. The non-transitory computer-readable medium of claim 14, wherein the second online retailer is the first online retailer.

19. The non-transitory computer-readable medium of claim 14, wherein the first purchase shipping data is associated with a first common carrier.

20. The non-transitory computer-readable medium of claim 19, wherein the second purchase shipping data is associated with the first common carrier.

21. The non-transitory computer-readable medium of claim 19, wherein the second purchase shipping data is associated with a second common carrier.

22. The non-transitory computer-readable medium of claim 21, wherein the first user purchase history further comprises data associated with a purchased item returned to a third online retailer from the first user.

23. The non-transitory computer-readable medium of claim 22, wherein the third online retailer is a retailer selected from a group consisting of:
(A) the first online retailer; and
(B) the second online retailer.

24. The non-transitory computer-readable medium of claim 14, wherein the first purchase purchasing data and the first purchase shipping data are collected at substantially the same time.

25. The non-transitory computer-readable medium of claim 14, wherein the first purchase purchasing data is collected before the first purchase shipping data.
